(19) United States
(12) Patent Application Publication
(10) Pub. No.: US 2009/0277063 A1
(43) Pub. Date: Nov. 12, 2009

(54) Display clip and system

(76) Inventor: James Lee, Old Tappan, NJ (US)

Correspondence Address: FROMMER LAWRENCE & HAUG, 745 FIFTH AVENUE- 10TH FL., NEW YORK, NY, 10151, US

(21) Appl. No.: 12/151,663

(22) Filed: May 8, 2008

(51) Int. Cl. G09F 7/18

(52) U.S. Cl. 40/658

(57) ABSTRACT

A display system includes one or more display clips mounted on a display unit. Each display clip has a mounting portion with a channel or groove shaped for disposing over a section of a display support, with each display support having edges with one or more slits or openings. The display clip comprises a retainer positioned cross-sectional to the channel. The clip mounts on the edge of the display support, and the retainer inserts into a slit or opening in the edge. The retainer fixes the display clip to the display support at the point of the insertion. Each clip has a brace portion extending from the mounting portion of the display clip. When the display clip is mounted on the display support, the brace portion supports the item being displayed in position.

### BACKGROUND OF THE INVENTION

1. Field of the Invention

The invention relates generally to a display system. More particularly, the invention pertains to a display clip which secures easily to a fixed position on a display support.

2. Description of Related Art

Merchandise is often packaged in boxes. A number of the boxed merchandise are shipped in a shipping container to a retailer. The shipping container may be a larger cardboard box. The retailer can display the boxed merchandise using the larger shipping box. One type of shipping container is called a “cut-case box.” In a “cut-case box,” part of the box is cut away. The remaining portions of the sides of the cut-case box can act as a display support to display the boxed merchandise inside. Oblong merchandise boxes may be stood on end vertically and stacked front-to-back of a cut-case box. Alternatively, the boxed merchandise may be stacked horizontally top-to-bottom. A portion of the sides of the cut-case box are cut away. The arrangement enables a prospective purchaser to see more of the packaging of the boxed merchandise and also to easily remove the boxed merchandise from the display. Purchasers may take one of the boxed merchandise from anywhere in the stack and leave the remaining boxed merchandise in the cut-case box.

### SUMMARY OF THE DISCLOSURE

In one aspect of the invention, a display clip comprises a mounting portion and a brace portion. The mounting portion comprises a channel having a retainer positioned across the channel. The brace portion extends from the channel for holding a displayed item in place. A display system includes a display clip mounted on a display support having an edge and one or more slits or openings along the edge. The display clip is mounted on the display support by placing the channel over the edge of the display support, and placing the cross-wise retainer into a slit or opening on the edge to fix the display clip to the position of the slit or opening. The brace portion extends from the display clip, providing support to an item disposed in the display system. A display system can include a plurality of display clips mounted on a display support.

In a particular embodiment of the display system, the display clip is mounted on the top edge of a display support having a rectangular shape. The display clip has a flat, vertical brace extending from the channel perpendicularly to the channel. A second display clip can be mounted on the top edge of another wall such that an item is supported by more than one brace. With a rectangular display support, the display clips can be mounted on opposing walls.

In another aspect of the invention, an apparatus and method for assembling a display system includes mounting additional display clips on the display support. A display clip can be placed over the edge of the display support at the next desired location on the edge, inserting the retainer in the slit, and putting a second unit of the item between the brace of the second clip and the previously-placed item.

In a third aspect of the invention, the retainer of the display clip has a shaped edge that can be used for marking the position of the slit or opening on the display support. Also, the display clip can have a sharp edge in another embodiment to enable cutting into a display support, such as a cardboard display support that has no pre-made slit or opening, at the time of mounting the display clip.

### BRIEF DESCRIPTION OF THE DRAWINGS

FIG. 1A illustrates assembly of an embodiment of a display clip on an edge of a display support;

FIG. 1B illustrates top view of a display clip according to the present disclosure;

FIG. 2 illustrates a perspective view of an embodiment of a shelving system according to the present disclosure; and

FIG. 3 illustrates a perspective view of another embodiment of a shelving system according to the present disclosure.

### DETAILED DESCRIPTION

In general, the display system of the present disclosure includes one or more display clips that can be mounted on a display support. Each display support has edges or walls. The display clip has a brace portion and a mounting portion. The mounting portion holds the display clip to the display support. The brace portion can be attached perpendicularly to the display support edge when the display clip is mounted on the display support. The display clip may be mounted to the display support edges or walls in any convenient way. In one implementation, slits or openings may be cut along the display support edges or walls for inserting a retainer portion of the display clip.

The display clip can have a channel, a retainer portion positioned across the channel, and a brace extending from the channel which can hold an item of boxed merchandise placed in a display support. The channel of the display clip can be placed over the edge of the display support, and the retainer portion is inserted into the slit or opening along the edge to place the brace at a desired location, depending on the design of the display clip. The display retainer can prevent the clip from moving along the edge of the display support, and the brace on the clip can prevent the item from moving within the display support. Additional display clips can be mounted at desired intervals to display additional items.

The display clips can be reused, and the retainer can have a shaped edge to mark the position on the display support for making an opening or slit for inserting the retainer.

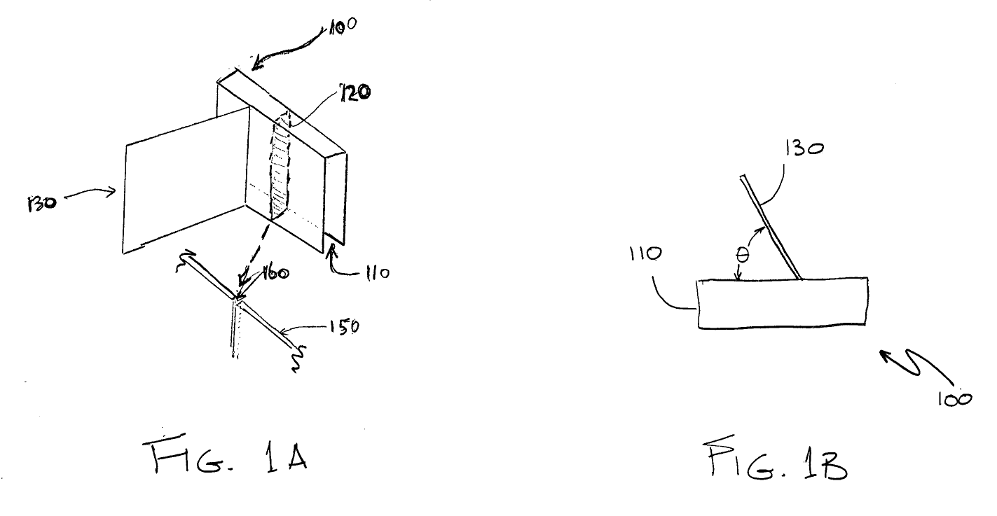

FIG. 1A illustrates assembly of an embodiment of a display clip 100 on an edge 150 of a display support with a slit 160. Display clip 100 has a mounting portion that includes a channel 110, a retainer portion 120 across the channel width, and a brace 130 extending from the channel.

Other mounting portions may be used such that the display clip, when mounted on a display support edge, has the brace 130 perpendicular to the display support edge 150.

Display clip 100 is mounted on display support edge 150 by placing channel 110 over edge 150, and adjusting the position of the clip 100 until retainer 120 is positioned over slit 160, and inserting it. Thus inserted into slit 160, retainer 120 keeps clip 100 from moving along the edge 150 of display support. Brace 130 extends from display clip 100 to support an item placed in the display support in position. This process may be repeated for any additional display clip 100 used for supporting the item or additional items according to the design of the display system.

In one embodiment, channel 110 is U-shaped, but the shape of the channel can be V-shaped, round or angular, and can narrow towards the tips, in the shape of a horseshoe or a binder clip. In a particular embodiment, the channel is rectangular and is mounted on the rectangular edge 150 of a display support.

Brace 130 is substantially flat, although it can be curved or shaped to accommodate the item placed in the display support. FIG. 1B illustrates a top view of display clip 130 having channel 110 and brace 130 extending therefrom. Brace 130 can extend from channel 110 at an angle θ (theta), which may be any desired angle. Brace 130 may extend perpendicularly from the channel 110 of clip 100, or obliquely to the channel if desired, as shown in FIG. 1B.

In a particular embodiment retainer 120 has a straight edge, but a shaped edge can be used to mark the location of slits or openings to be made on the edge 150 of a display support. Retainer 120 can have a sharp edge for conveniently cutting into the edge 150 as clip 100 is mounted on edge 150 by pushing channel 110 over the edge. In such an embodiment retainer 120 can be made shorter than the height of the channel to avoid cuts to users. Retainer 120 can be straight across the channel width as shown in FIG. 1A, or can be diagonally across the channel for insertion into a mating opening or slit on the edge of the display support.

In general, display clip 100 can be made of plastic, metal or any other suitable material.

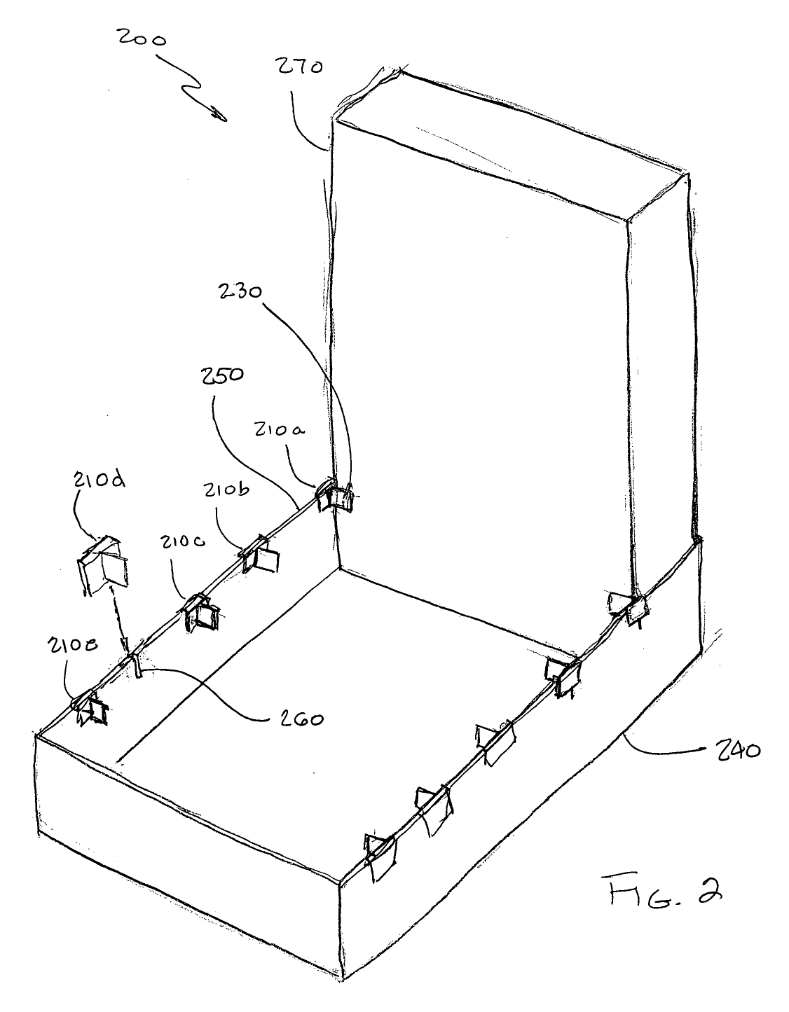

FIG. 2 illustrates a perspective view of an embodiment of a display system 200 including clips 210a-210e. Each display clip is mounted on a display support 240, by placing the channel of display clip 210 over display support edge 250 and inserting retainer into slit 260. This prevents movement of display clip 210 along the edge 250 of display support 240. Brace 230 extends from the clip 210 to support item 270 in position, and is able to keep item 270 upright even when another merchandise unit is removed from the display support and any remaining un-braced unit were to tilt and lean against item 270. It can be seen that display clips can be placed intermittently among several merchandise units, or one for each unit. In a particular embodiment brace 230 is rectangular, however other shapes may be used such as triangular.

In a particular embodiment display support 240 has a rectangular box as with a cardboard cut-case box. However, the display support can be round or any other shape. Also the display support can be a frame having edges for mounting a channel of the display clip, with openings, slits, notches or the like along the edges of the support for receiving retainers of display clips. Display support 240 can be made of cardboard, plastic, metal or any suitable material for providing support for the display clip 210 and item 270.

When installed, an item placed within display support is held in place by the brace attached to the display clip. The clip can prevent the items from falling down when adjacent items are removed from the display support, or when the display support is moved or tilted. The position of the display clip can be adjusted to display items of various dimensions, and can also be reused with any suitable support.

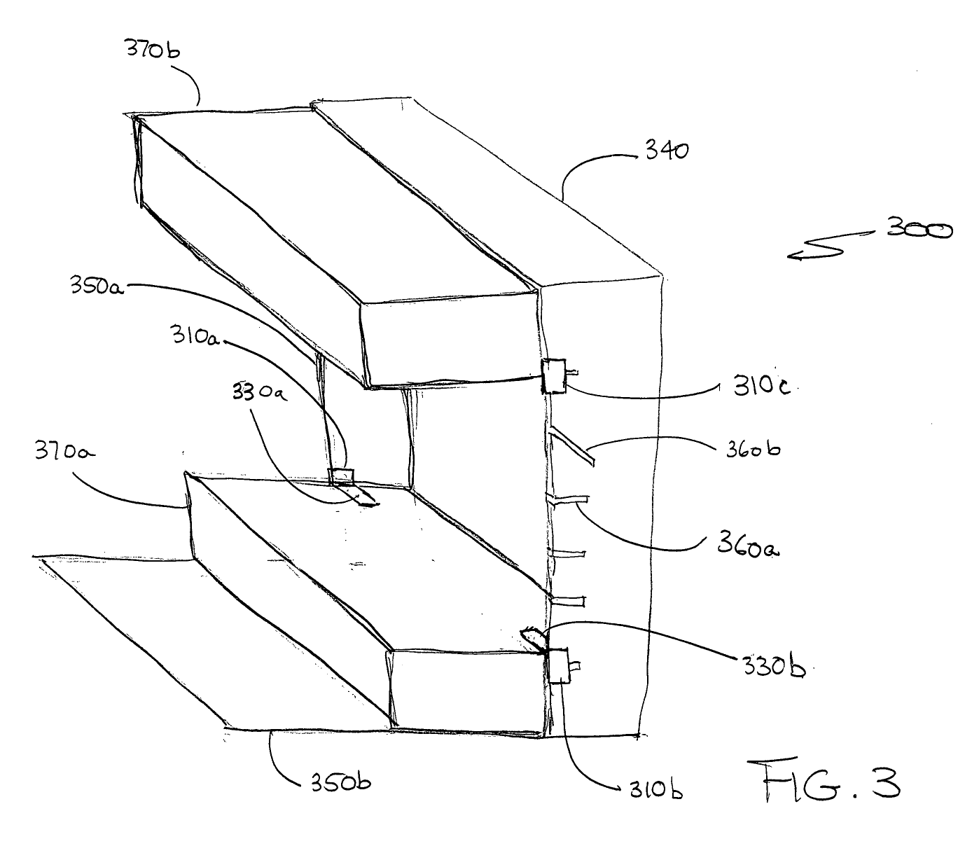

FIG. 3 illustrates a perspective view of an embodiment of a vertical display system 300 including display clips 310a and 310b, located at opposing edges of vertical display support 340, wherein braces 330a and 330b keep item 370a in place. Likewise, braces on display clips 310c and a corresponding display clip (not shown) can keep item 370b at the top of the vertical display support 340 even though no items support item 370b from below. Thus this system may withstand randomly removing items from the display, as by shoppers from a retail display. Display clips 310a, 310b, 310c may be mounted to display support 340 by inserting a retainer (not shown) of a display clip 310 into a slit 360, as discussed herein above. In one particular embodiment, opening or slit 360b on display support edge 350 is slanted downward, into which retainer on display clip 310 inserts downward. Slit 360a may, alternatively, be perpendicular. In another embodiment display support edge 350b can be included at the bottom of the display support 340 to add stability to the vertical display system 300.

Other embodiments are within the scope of the following claims.

What is claimed is:

1. A display clip for a display support defining a cavity, comprising:
a mounting portion to retain the display clip to a wall of the display support; and
a brace attached to the mounting portion,
wherein, when the display clip is mounted on the display support, the brace extends into the display support cavity.

2. The display clip of claim 1 wherein the mounting portion comprises:
a channel to receive the wall of the display support; and
a retainer disposed within the channel and positioned cross-sectionally to the channel.

3. A display clip as in claim 2, wherein the brace is substantially flat.

4. A display clip as in claim 2, wherein the brace extends from the channel perpendicularly to the channel.

5. A display clip for a display support as in claim 2, wherein the retainer has a shaped edge.

6. A display clip for a display support as in claim 2, wherein the retainer has a sharp edge capable of cutting into a top edge of the display support wall.

7. A display system comprising:
one or more display clips each comprising a mounting portion to retain the display clip to a wall of the display support, wherein the mounting portion comprises a channel, a retainer disposed within the channel and positioned cross-sectionally to the channel, and a brace attached to the mounting portion; and
a display support defining a cavity and having an edge with one or more openings along the edge,
wherein each display clip is mounted on the display support by disposing the channel over the edge with the brace extending into the cavity,
wherein the retainer engages an opening along the edge,
wherein, when an item is disposed in the display support, the item is supported by the brace.

8. A display system as in claim 7, wherein the display support is made of cardboard.

9. A display system as in claim 7, wherein the display support is a cut-case box.

10. A display system of claim 7, wherein the display support is rectangular, and includes a first display clip is mounted on a top edge of a first wall of the display support, and a second display clip is mounted on a top edge of a second wall opposite the first wall at a corresponding location,
wherein, when an item is disposed in the display support cavity, the item is supported by the first and second display clips.

11. A display system of claim 10,
wherein the display clip comprises a substantially flat retainer, and a substantially flat brace extending from the channel perpendicularly to the channel,
wherein the display support is a cut-case box having one or more slits along the edges.

12. A method of assembling a display system, comprising:
mounting a display clip having a mounting portion and a brace to an edge of a display support defining a cavity,
wherein the brace extends into the display support cavity,
wherein, when an item is disposed in the display support cavity, the item is supported by the brace of the display clip.

13. A method of assembling a display system, comprising:
providing one or more display clips each having a channel shaped to receive a top edge of a display support defining a cavity, the display support having one or more slits along a top edge, said channel having a retainer positioned cross-sectionally to the channel and sized for insertion into the slit on the edge, and a brace extending from the display clip;
mounting each display clip by disposing the channel over the top edge;
sliding each clip along the edge until the retainer is adjacent a slit;
inserting the retainer into the slit,
wherein movement of each display clip along the edge is inhibited when the retainer engages the slit,
wherein, when an item is disposed in the display support cavity, braces of the display clips hold the item in position.

14. A method of assembling a display system as in claim 13,
wherein the display support is rectangular,
wherein a first display clip is mounted on a top edge of a first wall of the display support, and a second display clip is mounted on a top: edge of a second wall opposite the first wall at a corresponding location,
wherein, when an item is disposed in the display support cavity, the item is supported by the first and second display clips.
